(19) United States
(12) Patent Application Publication
(10) Pub. No.: US 2013/0111268 A1
(43) Pub. Date: May 2, 2013

(54) TESTING DEVICE CAPABLE OF SIMULATING PLUGGING AND UNPLUGGING OPERATIONS AND METHOD THEREOF

(71) Applicants: Yuan-Yuan GONG, Shenzhen City (CN); Zheng-Quan PENG, Shenzhen City (CN); Qiong CAI, Shenzhen City (CN)

(72) Inventors: Yuan-Yuan GONG, Shenzhen City (CN); Zheng-Quan PENG, Shenzhen City (CN); Qiong CAI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/337,307

(22) Filed: Dec. 27, 2011

(30) Foreign Application Priority Data
Oct. 31, 2011 (CN) 201110337801.3

(51) Int. Cl. G06F 11/263

(52) U.S. Cl. 714/32; 714/E11.177

(57) ABSTRACT

A testing device is capable of simulating plugging and unplugging operations in relation to an USB port of an electronic device. The testing device comprises a processing unit to detect an electrical connection between the testing device and the USB port, and to control an indicator to cycle between a state of recognizability and a state of unrecognizability even though a physical connection to the USB port of the electronic device exists at all times. The state of recognizability indicates the testing device is capable of being recognized by the electronic device, and the state of unrecognizability indicates the testing device is incapable of being recognized by the electronic device. Reading and writing tests are carried out by the testing device each time that recognizability is indicated, to repeatedly test the integrity of the USB port being tested.

### BACKGROUND

1. Technical Field

The present disclosure relates to testing devices capable of simulating plugging and unplugging operations and testing methods.

2. Description of Related Art

A device with a USB plug, such as a mouse, may be plugged into the USB port of an electronic device to test whether data from the device can be written to the electronic device and whether data stored in the electronic device can be transmitted out through the USB port and read correctly by the device. When each test is finished, the mouse is unplugged from the USB port. Many tests for each USB port are required to ensure the correct functioning of the USB port. However, the plugging and unplugging operations carried out many times may import contaminants into the USB port of the electronic device, or even damage it. Moreover, the plugging and unplugging operations are done manually, which lowers test-time efficiency. Therefore, a testing device capable of testing the USB ports of electronic devices and avoiding the numerous plugging and unplugging operations is needed.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a schematic, block diagram of a testing device capable of simulating plugging and unplugging operations to at least one USB port of an electronic device, in accordance with an exemplary embodiment.

FIG. 2 is a flowchart of a testing method to test the reading and writing functions of the at least one USB port of the electronic device of FIG. 1, in accordance with an exemplary embodiment.

### DETAILED DESCRIPTION

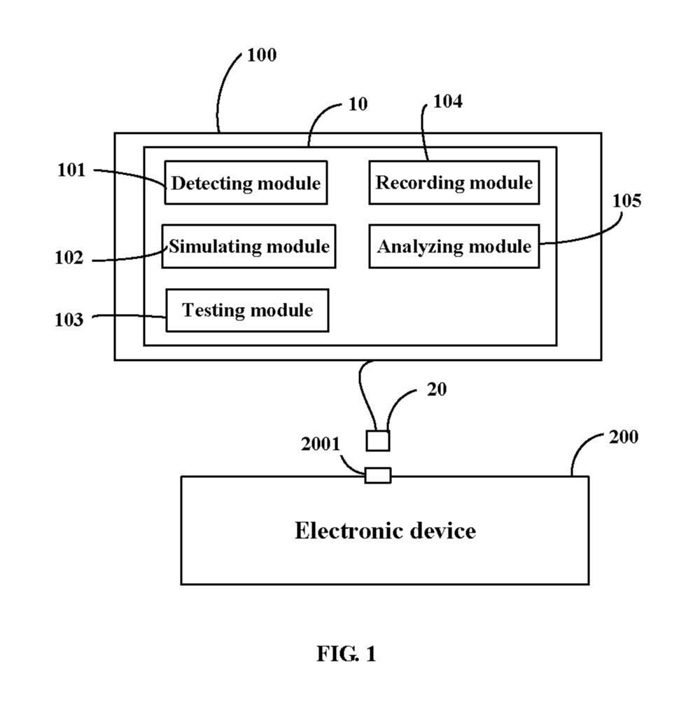

Referring to FIG. 1, a testing device 100 is electrically connected to an electronic device 200 by plugging a USB plug 20 of the device 100 into at least one USB port 2001 of the electronic device 200. The testing device 100 may be the physical size of a mouse and in addition perform the functions of a mouse, or may resemble and perform functions similar to those of a USB flash drive. The electronic device 200 may be a notebook, a Personal Digital Assistant (PDA), or the like, equipped with at least one USB port. When the testing device 100 is electrically connected to the USB port 2001 of the electronic device 200, the electronic device 200 automatically recognizes the testing device 100. The testing device 100 can simulate repeated plugging and unplugging operations in relation to the electronic device 200 while the testing device 100 is physically connected to the electronic device 200, to test the reading and writing (R/W) functions of the USB port 2001. For example, the testing device 100 can determine whether data read and data written through the USB port 2001 is read and written correctly to test the R/W functions of the USB port 2001.

The testing device 100 provides an indicator for indicating a state of recognizability or a state of unrecognizability of the testing device 100. When the indicator indicates the state of recognizability, the device 100 can be recognized by the device 200 as long as the device 100 is electrically connected to the device 200. When the indicator indicates the state of unrecognizability, the device 100 cannot be recognized by the device 200 even when the device 100 is electrically connected to the device 200. For example, the indicator may be a digital 1 or logical high signal representing the state of recognizability, and a digital 0 or logical low signal representing the state of unrecognizability. When the indicator switches from a logical low signal to a logical high signal, a simulation of a plugging in operation to make a connection is being carried out; and when the indicator switches from a logical high signal to a logical low signal, a simulation of a disconnection by being unplugged is being carried out.

The testing device 100 includes a processing unit 10. The processing unit 10 includes a detecting module 101 and a simulating module 102. The detecting module 101 detects an electrical connection between the testing device 100 and the USB port 2001 of the electronic device 200. For example, when detecting that a power pin (not shown) of the port 20 reaches a high level voltage, the detecting module 101 determines that the testing device 100 is electrically connected to the port 2001.

The simulating module 102 is configured to control the indicator of the device 10 to cycle between the state of recognizability and the state of unrecognizability, so as to simulate the plugging in operations and the unplugging operations, without interrupting the physical connection between the testing device 100 and the port 2001 of the electronic device 200. For example, if the state of recognizability and the state of unrecognizability are represented by a digital one signal and by a digital zero signal respectively, the simulating module 102 can set the indicator to cycle between a one and a zero.

The processing unit 10 further includes a testing module 103, a recording module 104, and an analyzing module 105.

The testing module 103 tests the R/W functions of the USB port 2001 each time the testing device 100 indicates a state of recognizability. In this embodiment, the testing module 103 writes a test file stored in the testing device 100 into the electronic device 200, compares the file received by the electronic device 200 with the stored test file, and determines that the current test of the R/W functions of the USB port 2001 is successful if the received file is the same as the stored test file. In another embodiment, the testing module 103 further tests a writing speed of the test file being written to the electronic device 200 and a speed at which the received file can be read from the electronic device 200, the testing module 103 determines that the current test is successful if the writing speed of a test file correctly written into the electronic device 200 reaches a predetermined value, and if the speed at which the received file can be correctly read reaches a predetermined value.

The recording module 104 records a result of each test of the USB port(s) 2001 until the number of tests carried out reaches a predetermined value. The analyzing module 105 determines that the R/W functions of the USB port 2001 are working correctly if a ratio of the successful tests to the total number of tests carried out reaches a certain percentage, such as 95%.

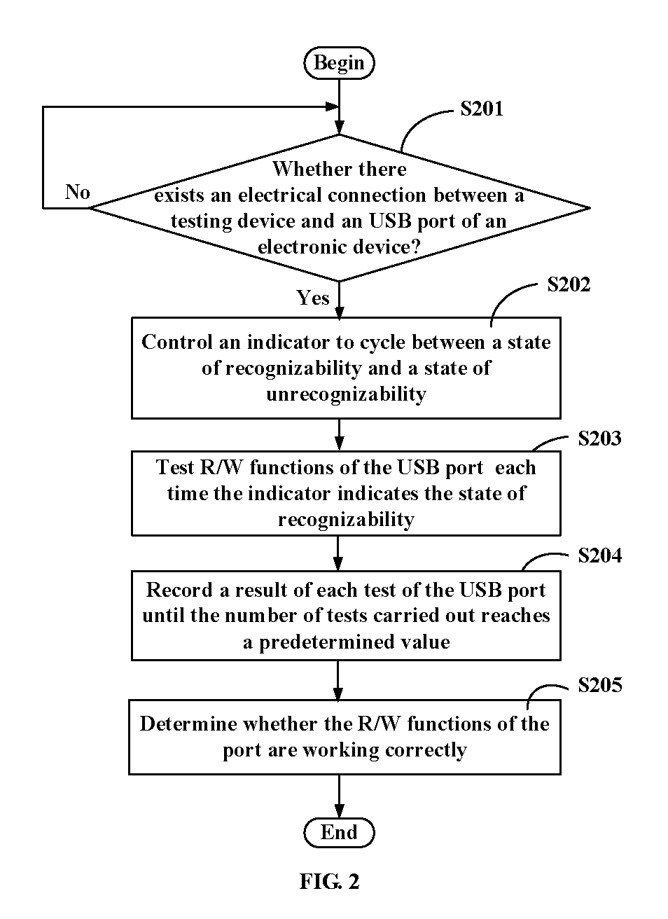

Referring to FIG. 2, a flowchart of a testing method to test the R/W functions of the at least one USB port of the electronic device is shown.

In step S201, the detecting module 101 is implemented by the processor 10 to detect an electrical connection between the testing device 100 and the USB port 2001 of the electronic device 200. If an electrical connection exists, the procedure goes to step S202, otherwise, the procedure repeats step S201.

In step S202, the simulating module 102 is implemented by the processor 10 to control the indicator to cycle between a state of recognizability and a state of unrecognizability.

In step S203, the testing module 103 is implemented by the processor 10 to test the R/W functions of the USB port 2001 each time the testing device 100 indicates a state of recognizability.

In step S204, the recording module 104 is implemented by the processor 10 to record a result of each test of the USB port(s) 2001 until the number of tests carried out reaches a predetermined value.

In step S205, the analyzing module 105 is implemented by the processor 10 to determine that the R/W functions of the USB port 2001 are working correctly if the ratio of the successful tests to the total number of tests carried out reaches a certain percentage.

In this embodiment, in step S203, the testing module 103 is implemented by the processor 10 to write a test file stored in the testing device 100 into the electronic device 200, to compare the correctness of the file actually received by the electronic device 200 with the stored test file, and determine that the current test of the R/W functions of the USB port 2001 is successful if the received file is the same as the stored test file. In another embodiment, the testing module 103 is further implemented by the processor 10 to test a writing speed of the test file being written to the electronic device 200 and the speed at which the received file can be read from the electronic device 200, and the testing module 103 determines that the current test(s) is successful if the writing speed of a test file correctly written into the electronic device 200 reaches a predetermined value, and if the speed at which the received file can be correctly read reaches a predetermined value.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A testing device capable of simulating plugging and unplugging operations to an electronic device, the testing device comprises a USB port, and a processing unit to:
detect an electrical connection between the testing device and the USB port of the electronic device; and
control an indicator of the testing device to cycle between a state of recognizability and a state of unrecognizability when the testing device is electrically connected to the USB port of the electronic device, wherein when the indicator indicates the state of recognizability, the testing device is capable of being recognized by the electronic device when the testing device is electrically connected to the device, and when the indicator indicates the state of unrecognizability, the testing device is incapable of being recognized by the electronic device when the testing device is electrically connected to the electronic device.

2. The testing device as described in claim 1, wherein the processing unit is further configured to:
test reading and writing functions of the USB port each time the indicator indicates the state of recognizability;
record a result of each test until a number of tests carried out reaches a predetermined value; and
determine the reading and writing functions of the USB port are working correctly if a ratio of successful tests to a total number of tests carried out reaches a certain percentage.

3. The testing device as described in claim 2, wherein when testing reading and writing functions of the USB port each time, the processing unit writes a test file stored in the testing device into the electronic device, compares a file received by the electronic device with the test file, and determines a current test of the reading and writing functions of the USB port is successful if the received file is the same as the test file.

4. The testing device as described in claim 2, wherein when testing reading and writing functions of USB port each time, the processing unit writes a test file stored in the testing device into the electronic device, compares a file received by the electronic device with the test file, tests a writing speed of the test file being written to the electronic device and a speed at which the received file is read from the electronic device, and the processing unit determines a current test is successful if the writing speed of the test file correctly written into the electronic device reaches a first predetermined value, and if the speed at which the received file is correctly read reaches a second predetermined value.

5. The testing device as described in claim 2, wherein the testing device is shaped as a mouse or an USB flash drive.

6. A testing method for simulating plugging and unplugging operations of a testing device to an electronic device, the testing method comprising:
detecting an electrical connection between the testing device and the USB port of the electronic device; and
controlling an indicator of the testing device to cycle between a state of recognizability and a state of unrecognizability when the testing device is electrically connected to the USB port of the electronic device, wherein when the indicator indicates the state of recognizability, the testing device is capable of being recognized by the electronic device when the testing device is electrically connected to the device, and when the indicator indicates the state of unrecognizability, the testing device is incapable of being recognized by the electronic device when the testing device is electrically connected to the electronic device.

7. The testing method as described in claim 6 further comprising steps:
testing reading and writing functions of the USB port each time the indicator indicates the state of recognizability;
recording a result of each test until a number of tests carried out reaches a predetermined value; and
determining the reading and writing functions of the USB port are working correctly if a ratio of successful tests to a total number of tests carried out reaches a certain percentage.

8. The testing method as described in claim 7, wherein when testing reading and writing functions of the USB port each time, the testing method comprising:
writing a test file stored in the testing device into the electronic device;
comparing a file received by the electronic device with the test file; and
determining a current test of the reading and writing functions of the USB port is successful if the received file is the same as the test file.

9. The testing method as described in claim 7, wherein when testing reading and writing functions of the USB port each time, the testing method comprising:
writing a test file stored in the testing device into the electronic device;
comparing a file received by the electronic device with the test file;
testing a writing speed of the test file being written into the electronic device and a speed at which the received file is read from the electronic device; and
determining a current test is successful if the writing speed of the test file correctly written into the electronic device reaches a first predetermined value, and if the speed at which the received file is correctly read reaches a second predetermined value.
